(19) United States
(12) Patent Application Publication
(10) Pub. No.: US 2016/0072756 A1
(43) Pub. Date: Mar. 10, 2016

(54) Updating a Sender of an Electronic Communication on a Disposition of a Recipient Toward Content of the Electronic Communication

(71) Applicant: International Business Machines Corporation, Armonk, NY (US)

(72) Inventors: Aleksandr Aravkin, Bronx, NY (US); Robert G. Farrell, Cornwall, NY (US); Dimitri Kanevsky, Ossining, NY (US); Tara N. Sainath, New York, NY (US)

(21) Appl. No.: 14/481,982

(22) Filed: Sep. 10, 2014

(51) Int. Cl. H04L 12/58; G06F 17/27

(52) U.S. Cl. CPC H04L 51/18; G06F 17/2785

(57) ABSTRACT

Determining a disposition of an electronic communication recipient is provided. An electronic communication is received from a sender. The electronic communication is sent to a recipient. Then, captured biometric data is received corresponding to the recipient of the electronic communication indicating the disposition of the recipient toward the content of the electronic communication while the recipient was perceiving the electronic communication.

### BACKGROUND

1. Field

The disclosure relates generally to electronic communications and more specifically to updating a sender of an electronic communication, which was sent via a network, on a disposition of a recipient toward content of the electronic communication.

2. Description of the Related Art

Electronic communication systems, such as, for example, voice messaging systems, video messaging systems, text messaging systems, e-mail messaging systems, voicemail messaging systems, video mail systems, and the like, are a way for a user to privately communicate with another person or persons using multimedia content for an electronic communication. Typically, users of these electronic communication systems will record a video message or voice message and/or type a textual message in an electronic communication and then send the electronic communication to one or more other users that can reply to the electronic communication. Using these electronic communication systems, users primarily focus on the content of the electronic communications and not on the feelings of the users toward the content contained in the electronic communications.

### SUMMARY

According to one illustrative embodiment, a computer-implemented method for determining a disposition of an electronic communication recipient is provided. A computer receives an electronic communication from a sender. The computer sends the electronic communication to a recipient. The computer receives captured biometric data corresponding to the recipient of the electronic communication indicating the disposition of the recipient toward the content of the electronic communication while the recipient was perceiving the electronic communication. According to other illustrative embodiments, a computer system and a computer program product for determining a disposition of an electronic communication recipient are provided.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a disposition determination system in accordance with an illustrative embodiment;

FIG. 4 is a diagram illustrating a communication frame in accordance with an illustrative embodiment;

FIG. 5 is a diagram illustrating database tables in accordance with an illustrative embodiment;

FIG. 6 is a diagram illustrating a login screen in accordance with an illustrative embodiment;

FIG. 7 is a diagram illustrating a disposition analyzer component in accordance with an illustrative embodiment;

FIG. 8 is a diagram illustrating a disposition analysis component in accordance with an illustrative embodiment;

FIG. 9 is a diagram illustrating a registration screen in accordance with an illustrative embodiment;

FIG. 10 is a flowchart illustrating a process for generating a disposition score corresponding to a disposition of a recipient toward content of an electronic communication in accordance with an illustrative embodiment;

FIG. 11 is a flowchart illustrating a process for sending captured biometric data corresponding to a recipient of an electronic communication indicating a disposition of the recipient toward a content of the electronic communication and an indicated disposition toward the content of the electronic communication inputted by the recipient in accordance with an illustrative embodiment;

FIG. 12 is a flowchart illustrating a process for sending an indicator of a disposition of a recipient toward a content of an electronic communication to a sender of the electronic communication in accordance with an illustrative embodiment; and

FIG. 13 is a flowchart illustrating a process for automatically generating a disposition score corresponding to a disposition of a recipient toward content of an electronic communication in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

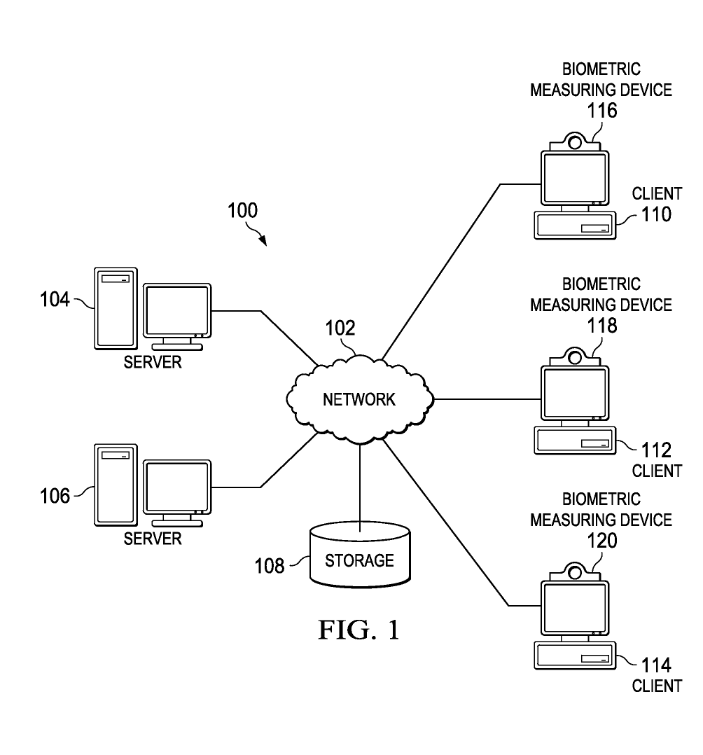

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other data processing devices in which the illustrative embodiments may be implemented. Network data processing system 100 contains network 102, which is the medium used to provide communications links between the computers and the other data processing devices connected together within network data processing system 100. Network 102 may include connections, such as wire communication links, wireless communication links, or fiber optic cables.

In the depicted example, server 104 and server 106 connect to network 102, along with storage 108. Server 104 and server 106 may be, for example, server computers with high-speed connections to network 102. In addition, server 104 and/or server 106 may provide services to client devices connected to network 102. For example, server 104 and/or server 106 may provide one or more electronic communication system services, such as, for example, voice messaging services, video messaging services, textual messaging services, instant messaging services, e-mail messaging services, voicemail messaging services, video mail services, and the like, to the client devices.

Clients 110, 112, and 114 also connect to network 102. Clients 110, 112, and 114 are clients to server 104 and/or server 106. In the depicted example, server 104 and/or server 106 may provide information, such as boot files, operating system images, and applications to clients 110, 112, and 114. Users of clients 110, 112, and 114 may utilize clients 110, 112, and 114 to access the electronic communication services provided by server 104 and/or server 106.

Clients 110, 112, and 114 may be, for example, personal computers, network computers, and/or portable computers, such as laptop computers, with wire and/or wireless communication links to network 102. In addition, clients 110, 112, and 114 also may represent mobile data processing systems, such as cellular telephones, smart phones, personal digital assistants, gaming devices, or handheld computers, with wireless communication links to network 102. It should be noted that clients 110, 112, and 114 may represent any combination of computers and mobile data processing systems connected to network 102.

In addition, clients 110, 112, and 114 include biometric measuring devices 116, 118, and 120, respectively. Clients 110, 112, and 114 utilize biometric measuring devices 116, 118, and 120 to automatically capture, measure, and record biometric data that corresponds to users of clients 110, 112, and 114 while the users are perceiving content of a private electronic communication. Perceiving means viewing, listening, and/or reading the content of the private electronic communication by a user. Private means that only the sender and sender designated recipients are able to perceive the electronic communication. In other words, the private electronic communication is not posted on a public web site, such as a social media web site or chat room, for non-designated users to view, hear, and/or read.

Each of biometric measuring devices 116, 118, and 120 may represent a set of one or more biometric measuring devices. For example, a set of biometric measuring devices may include at least one of a sound capturing device, such as a microphone, with speech analyzing capabilities, an image capturing device, such as a video camera, with facial analyzing capabilities, a brain imaging device, such as a functional magnetic resonance imaging (fMRI) device or a positron emission tomography (PET) device, with brain activity blood flow analyzing capabilities, and a skin arousal capturing device, such as a galvanic skin response (GSR) device, with skin arousal analyzing capabilities. As used herein, the phrase “at least one of”, when used with a list of items, means different combinations of one or more of the listed items may be used and only one of each item in the list may be needed. For example, “at least one of item A, item B, and item C” may include, without limitation, item A, item A and item B, or item B. This example also may include item A, item B, and item C or item B and item C. In other examples, “at least one of” may be, for example, without limitation, two of item A, one of item B, and ten of item C; four of item B and seven of item C; and other suitable combinations. In other words, at least one of means any combination of items and number of items may be used from the list but not all of the items in the list are required.

Storage 108 is a network storage device capable of storing data in a structured or relational format, such as in one or more tables consisting of columns and rows of data. Storage 108 may be, for example, an operational data store, data warehouse, or database. Storage 108 may provide storage of a plurality of different users and associated identification numbers; user profiles; user account information; a plurality of different types of electronic communications and associated information; and a plurality of disposition scores corresponding to different users. A disposition score is a numerical value that corresponds to a particular user's sentiment, emotion, or feeling toward content of a particular electronic communication. A disposition score may be automatically calculated by a server and may be manually inputted by a user. Further, storage unit 108 may store other data, such as authentication or credential data that may include user identifiers, passwords, and biometric data associated with each of the plurality of users.

Also, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

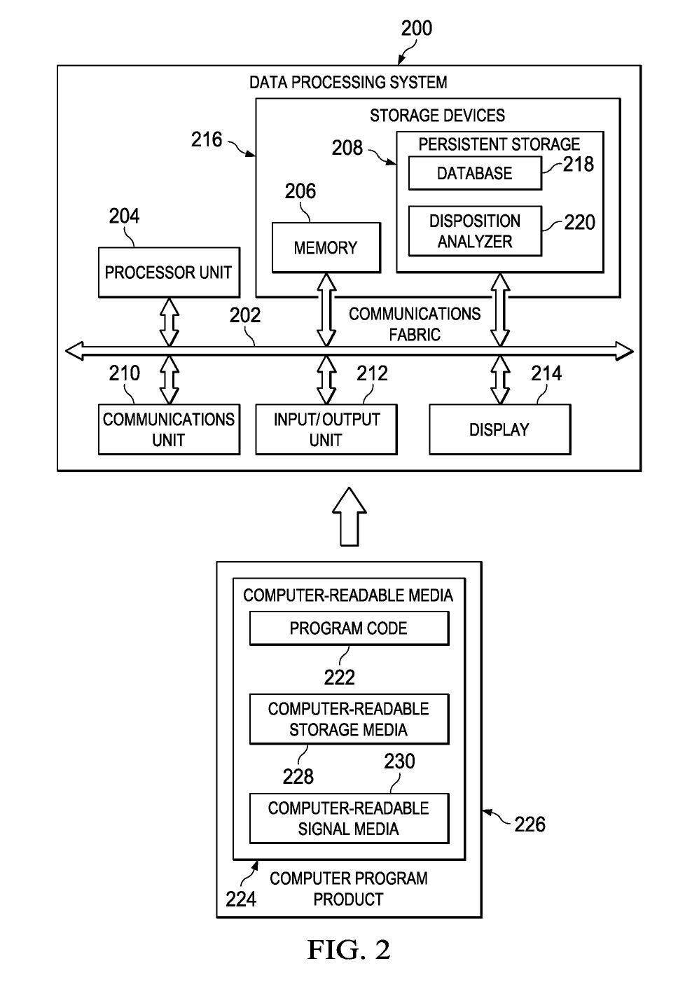

With reference now to FIG. 2, a diagram of a data processing system is depicted in accordance with an illustrative embodiment. Data processing system 200 is an example of a computer, such as server 104 or client 110 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications or programs that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of computer readable storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device does not include a propagation medium. Memory 206, in these examples, may be, for example, a random access memory, or any other suitable volatile or non-volatile storage device.

Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores database 218 and disposition analyzer 220. However, it should be noted that persistent storage 208 may store any type of application, program, module, and data utilized by the different illustrative embodiments. Database 218 is a relational database that stores a plurality of data records in a structured format in columns and rows. The data records stored in database table 218 may represent any type of data or information and may include any type of characteristics, attributes, or values. For example, database table 218 may store data records for a plurality of different users and their associated identification numbers, a plurality of different types of private electronic communications and associated information, and a plurality of disposition scores corresponding to the different users.

Disposition analyzer 220 is a software application that may analyze biometric data corresponding to a recipient's disposition toward content of an electronic communication sent to the recipient via a network from a sender of the electronic communication while the recipient was perceiving the electronic communication. In addition, disposition analyzer 220 may analyze a reply to the electronic communication authored by the recipient for indications of the recipient's disposition toward the content of the electronic communication using, for example, text analysis, video analysis, and/or voice analysis programs. Further, disposition analyzer 220 may receive a manual input from the recipient via the network indicating the recipient's disposition toward the content of the electronic communication. Furthermore, disposition analyzer 220 may calculate a total disposition score corresponding to the recipient of the electronic communication based on the biometric data captured while the recipient was perceiving the electronic communication, the recipient's reply to the electronic communication, and/or the manual disposition input by the recipient. Moreover, disposition analyzer 220 may send the total disposition score corresponding to the recipient of the electronic communication via the network to the sender of the electronic communication. Disposition analyzer 220 also may update the sender on the recipient's disposition on a continuous basis or on a predetermined time interval basis.

Communications unit 210, in this example, provides for communication with other data processing systems and computing devices. Communications unit 210 may provide communications through the use of either or both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user, such as system administrator. In addition, display 214 may include touch screen capabilities to receive user input.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206. These instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 222 is located in a functional form on computer readable media 224 that is selectively removable and may be loaded onto or transferred to data processing system 200 for running by processor unit 204. Program code 222 and computer readable media 224 form computer program product 226. In one example, computer readable media 224 may be computer readable storage media 228 or computer readable signal media 230. Computer readable storage media 228 may include, for example, an optical or magnetic disc that is inserted or placed into a drive or other device that is part of persistent storage 208 for transfer onto a storage device, such as a hard drive, that is part of persistent storage 208. Computer readable storage media 228 also may take the form of a persistent storage, such as a hard drive, a thumb drive, or a flash memory that is connected to data processing system 200. In some instances, computer readable storage media 228 may not be removable from data processing system 200.

Alternatively, program code 222 may be transferred to data processing system 200 using computer readable signal media 230. Computer readable signal media 230 may be, for example, a propagated data signal containing program code 222. For example, computer readable signal media 230 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 222 may be downloaded over a network to persistent storage 208 from another device or data processing system through computer readable signal media 230 for use within data processing system 200. For instance, program code stored in a computer readable storage media in a data processing system may be downloaded over a network from the data processing system to data processing system 200. The data processing system providing program code 222 may be a server computer, a client computer, or some other device capable of storing and transmitting program code 222.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 228 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In the course of developing illustrative embodiments it was discovered that no easy way exists for a sender of a private electronic communication, which may consist of a multimedia message, to request and/or determine the disposition of a set of one or more designated recipients of the private electronic communication toward the content of that private electronic communication. Currently, the sender can send a message, wait for a reply, and then manually integrate sentiment information received from one or more recipients of the message. However, this process is labor intensive and prone to error.

Alternatively, a multimedia track or icon, such as a sound of a trumpet blast, a smiley face, or an introduction video segment, can be added to an electronic communication to indicate the general feeling of a user. However, the reference is ambiguous. It simply becomes part of the electronic communication's content.

Social networking web sites have a simple way of indicating whether a given user (e.g., a responder) likes or dislikes a posting or comment of another user (e.g., a poster). The given user simply activates a graphical button for “like” or “dislike” on a screen and the number of likes and dislikes are tabulated for the other user to see. However, this tabulation of likes and dislikes and often which particular users liked or disliked the posting or comment is displayed for all users to see.

Recipients of an electronic communication may be reluctant or unable to provide a sentiment or emotion as part of their reply to the content of the electronic communication, but are willing to use a gesture or mouse click to indicate their sentiment or emotion. For example, electronic communication recipients with alexithymia, which is an inability to identify and describe emotions in oneself, autism, post-traumatic stress disorder, anorexia/bulimia, or major depression may be reluctant or unable to provide a sentiment or emotion as part of their reply to the content of the electronic communication. Illustrative embodiments provide a separate channel for determining a disposition of a recipient toward the content of an electronic communication. For example, a recipient of an electronic communication may not want to provide a reply because of being in a noisy room, but may want to quickly indicate an emotional response to the content of the electronic communication by providing a gesture or mouse click.

Also, there are occasions when a unique identifier, such as an e-mail address, of the user replying to the electronic communication is not known. This may occur when an electronic communication is sent anonymously. In this situation, illustrative embodiments may utilize biometric data analysis, in addition to disposition analysis, to determine who sent the reply message and to identify the recipient's disposition in a user-specific or user-dependent manner.

In addition, users may not just want the disposition of each recipient of an electronic communication, but also may want a summary of the total disposition of all the recipients of an electronic communication. When communicating in person, emotions and feelings about what is being said is often communicated through facial expressions and tone of voice. Illustrative embodiments mirror this in-person communication of emotions and feeling in electronic communication systems by generating a disposition score corresponding to a recipient toward content of an electronic communication by analyzing the video, voice, and/or text of the recipient as the recipient is viewing, listening to, and/or reading the content of the electronic message, analyzing the text/audio/video content of the recipient's reply, and/or having the recipient manually indicate disposition directly through a gesture or graphical user interface object, such as graphical button.

Illustrative embodiments utilize a separate, parallel channel for this disposition information and include an ability to analyze this disposition information in various ways, such as, for example, summarizing the disposition information. Illustrative embodiments also may utilize biometric data for identifying senders and receivers from the content of an electronic communication as part of the analysis process. In addition, illustrative embodiments utilize various ways of identifying an emotional response to the content of the electronic communication while a recipient is perceiving an electronic communication. Further, illustrative embodiments include ways for a sender of an electronic communication to indicate on a user interface that the sender would like to receive from a recipient of the electronic communication the recipient's disposition toward content of the electronic communication.

Thus, illustrative embodiments of the present invention provide a computer-implemented method, computer system, and computer program product for determining a disposition of an electronic communication recipient. A computer receives an electronic communication from a sender that includes an indication for a recipient of the electronic communication to provide a disposition of the recipient toward a content of the electronic communication. The computer sends the electronic communication to the recipient that includes the indication for the recipient to provide the disposition of the recipient toward the content of the electronic communication. Subsequently, the computer receives captured biometric data corresponding to the recipient of the electronic communication indicating the disposition of the recipient toward the content of the electronic communication while the recipient was perceiving the electronic communication.

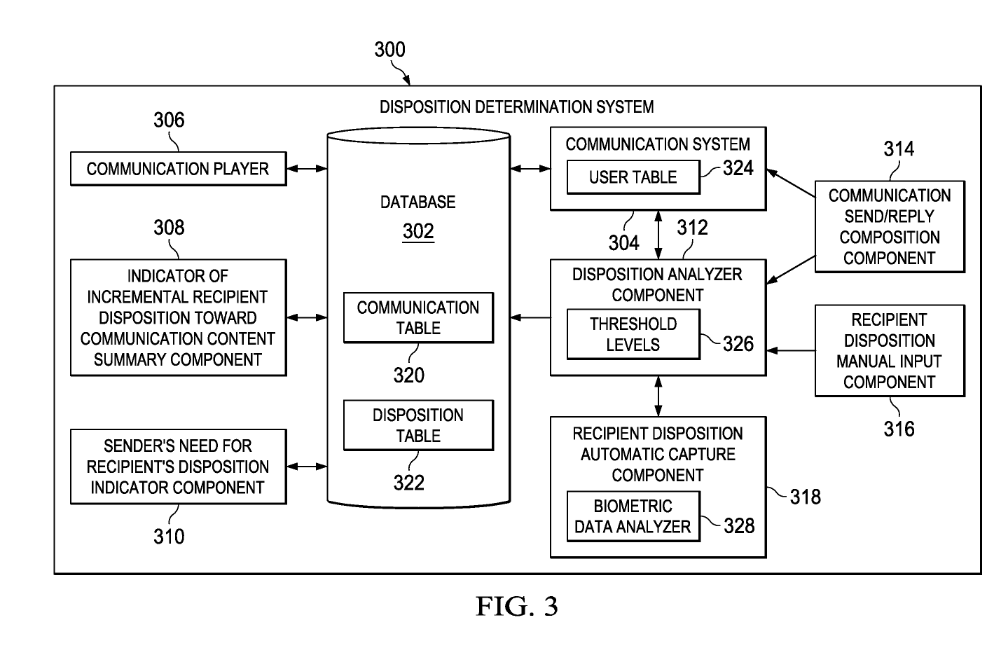

With reference now to FIG. 3, a diagram illustrating a disposition determination system is depicted in accordance with an illustrative embodiment. Disposition determination system 300 may be implemented in a network of data processing systems, such as, for example, network data processing system 100 in FIG. 1. Different components of disposition determination system 300 may be included in a relational database, such as storage 108 in FIG. 1, a user interface program running in a web browser of a client device, such as client 110 in FIG. 1, and a processing software application running on a server device, such as server 104 in FIG. 1.

In this example, disposition determination system 300 includes database 302, communication system 304, communication player 306, indicator of incremental recipient disposition toward communication content summary component 308, sender's need for recipient's disposition indicator component 310, disposition analyzer component 312, communication send/reply composition component 314, recipient disposition manual input component 316, and recipient disposition automatic capture component 318. However, it should be noted that disposition determination system 300 may include more or fewer components than shown. In others words, different illustrative embodiments may combine components, separate components, delete components, or add new components.

Database 302 is a relational database that stores communication table 320 and disposition table 322. In addition, database 302 also may store a user table, such as user table 324. Database 302 may be, for example, database 218 in FIG. 2.

Communication table 320 stores the content of private electronic communications, such as e-mails, text messages, video messages, voice messages, instant messages, and the like. In some illustrative embodiments, disposition determination system 300 may mark or tag the content of an electronic communication allowing a recipient's disposition to be associated only with particular portions or parts of an electronic communication. It should be noted that the different portions or parts of an electronic communication may be located in different communication mediums, such as video, text, or voice segments, associated with the electronic communication. Illustrative embodiments may combine the marking or tagging of the content in multiple parts of an electronic communication with the locations within the different communication mediums.

Dispositions table 322 stores the dispositions of different recipients toward content of an electronic communication, a manual disposition input, such as from a gesture made by a recipient or a graphical button input by the recipient, along a disposition value scale from −1 to 1 (e.g. −1, 0, 1), and a combined total disposition score from −1 to 1 for each electronic communication. Dispositions table 322 also may store summary dispositions corresponding to different sets of recipients. Illustrative embodiments may divide electronic communication recipients into different groups, each group having a different disposition toward content of an electronic communication, and the different dispositions may be directed toward different parts of an electronic communication.

Communication system 304 is an electronic communication system for sending and receiving electronic communications that may include multimedia content. Communication system 304 also may allow for electronic communication storage and retrieval. In this example, communication system 304 stores user table 324. User table 324 may store, for example, names and identification numbers for a plurality of users and address identifiers, passwords, and biometric data corresponding to each of the different users. It should be noted that alternative illustrative embodiments may store user table 324 outside of communication system 304, such as within database 302.

Communication player 306 outputs the multimedia content of a sent electronic communication or a reply electronic communication. For example, communication player 306 may play a video with an audio track, play a video without an audio track, play an audio track, and/or display a textual message. For example, communication player 306 may display a textual message throughout an entire video or audio track if multiple communication mediums are present in an electronic communication. Illustrative embodiments may utilize any type of communication player with multimedia capabilities or may utilize a communication player that plays only a single medium, such as, for example, video for video messages, audio for voicemail messages, or text for e-mail messages.

Indicator of incremental recipient disposition toward communication content summary component 308 periodically queries disposition table 322 for the disposition of recipients toward content of a particular electronic communication. In addition, indicator of incremental recipient disposition toward communication content summary component 308 displays the disposition of the recipients toward the content of the particular electronic communication at a location near that particular electronic communication being played in communication player 306. Further, indicator of incremental recipient disposition toward communication content summary component 308 also may display a disposition summary of all recipients of the electronic communication within communication player 306.

Sender's need for recipient's disposition indicator component 310 indicates to a recipient of an electronic communication that the sender of the electronic communication desires for the recipient to manually indicate the recipient's disposition toward the content of the electronic communication being played on communication player 306. For example, sender's need for recipient's disposition indicator component 310 displays a question mark graphic (?) on a portion of communication player 306's screen as a way of indicating to the recipient that manual input of the recipient's disposition is requested by the sender. When the recipient enters an input, such as a mouse click, over the question mark graphic, the question mark graphic turns into a heart graphic to indicate a positive disposition toward the content of the electronic communication and if the recipient enters another input over the heart graphic, then the heart graphic turns into a down arrow to indicate a negative disposition toward the content.

Disposition analyzer component 312 performs disposition analysis on electronic communication content sent from communication send/reply composition component 314, accepts input from recipient disposition manual input component 316, and accepts a recipient's automatically determined disposition toward content of an electronic communication from recipient disposition automatic capture component 318. Disposition analyzer component 312 may be, for example, disposition analyzer 220 in FIG. 2. In this example, disposition analyzer component 312 includes threshold levels 326. Threshold levels 326 represent a set of disposition threshold values which disposition analyzer component 312 utilizes to determine a recipient's disposition toward content of a particular electronic communication.

Disposition determination system 300 may automatically turn on recipient disposition automatic capture component 318 when communication player 306 displays and/or plays the content of an electronic communication. Disposition automatic capture component 318 may be, for example, biometric measuring device 116 in FIG. 1. Recipient disposition automatic capture component 318 performs recipient biometric data analysis using biometric data analyzer 328 to determine an identity of the recipient, if the identity of the recipient is not already known using registration data corresponding to the recipient. If recipient disposition automatic capture component 318 is able to determine the identity of the recipient, then recipient disposition automatic capture component 318 sends the recipient's identity information to communication system 304 for storage in user table 324 and also sends the recipient's identity information to database 302 for storage in communication table 320 and disposition table 322.

Communication send/reply composition component 314 accepts multimedia content, such as video messages, voice messages, and/or textual messages, to be included in an electronic communication from users, such as senders and recipients. Communication send/reply composition component 314 communicates information, such as when an electronic communication was sent and the timing of how long it took to record the content of the electronic communication, to disposition analyzer component 312.

Recipient disposition manual input component 316 accepts disposition information from recipients utilizing, for example, a graphical user input button displayed on a screen. Alternatively, recipient disposition manual input component 316 may accept a gesture performed by a recipient that is captured by an imaging device, such as a video camera. Illustrative embodiments may allow recipients to select graphical user input buttons while perceiving to an electronic communication being played on communication player 306 or may allow recipients to annotate the electronic communication with dispositions. If the graphical user input button is an icon, then recipient disposition manual input component 316 may round robin the icon between a heart shape, an empty shape, and a down arrow shape indicating different recipient dispositions, such as a positive disposition, an indifferent disposition, and a negative disposition, respectively.

Recipient disposition automatic capture component 318 uses biometric data analyzer 328 to determine the disposition of a recipient toward content of an electronic communication while the recipient is reading, viewing, or listening to the electronic communication. Once recipient disposition automatic capture component 318 determines that a confidence level corresponding to a recipient's disposition toward content of an electronic communication has reached or exceeded a disposition threshold, recipient disposition automatic capture component 318 adds the recipient's disposition to a portion of a reply electronic communication. Recipient disposition automatic capture component 318 analyzes a voice of a recipient for pitch energy, tone, et cetera, while the recipient is perceiving the electronic communication to determine the recipient's disposition toward the content using a sound capturing device, such as a microphone, for example. In addition, recipient disposition automatic capture component 318 may analyze the face of the recipient for positive or negative expressions using an image capturing device, such as a camera, for example. Further, recipient disposition automatic capture component 318 may include a brain imaging device, such as a functional magnetic resonance imaging device or a positron emission tomography device, to determine a recipient's disposition directly from activated parts of the recipient's brain. Furthermore, recipient disposition automatic capture component 318 may include a galvanic skin response device to determine arousal for determining the recipient's disposition. It should be noted that recipient disposition automatic capture component 318 is located on a client device, such as client 110 in FIG. 1, which is associated with a particular user.

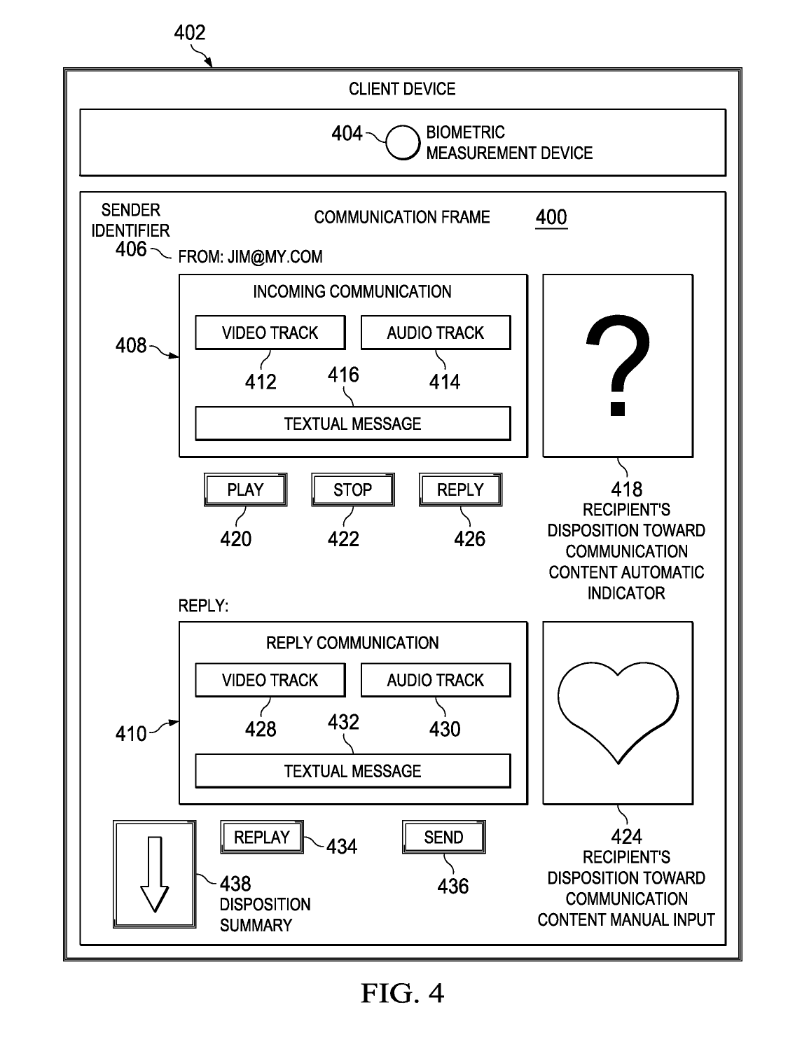

With reference now to FIG. 4, a diagram illustrating a communication frame is depicted in accordance with an illustrative embodiment. Communication frame 400 is a screen that displays and plays content of electronic communications. Communication frame 400 is implemented in client device 402, such as client 110 in FIG. 1. Client device 402 includes biometric measuring device 404, such as biometric measuring device 116 in FIG. 1. Biometric measuring device 404 automatically captures a recipient's disposition to content of an electronic communication while the recipient is perceiving the electronic communication.

In this example, communication frame 400 includes sender identifier 406, incoming communication 408, and reply communication 410. Incoming communication 408 includes video track 412, audio track 414, and textual message 416. Reply communication includes video track 428, audio track 430, and textual message 432. Communication frame 400 also includes recipient's disposition toward communication content automatic indicator 418, recipient's disposition toward communication content manual input 424, and disposition summary 438.

When an electronic communication arrives in an inbox from an electronic communication store, such as communication table 320 in FIG. 3, a communication player, such as communication player 306 in FIG. 3, loads the audio, video, and/or textual content of the electronic communication within communication frame 400. Sender identifier 406 indicates who sent incoming communication 408. Sender identifier 406 may be the result of biometric identification of a sender's electronic communication content.

The recipient of incoming communication 408 may press play 420 input button to play the loaded incoming communication 408 and while incoming communication 408 is playing press stop 422 input button to halt playing. The recipient may also press reply 426 input button to create a reply area within communication frame 400. Once the reply area is created within communication frame 400, a recording control button for record/stop appears in place of the reply 426 input button. The recipient may then start recording a voice reply message using a microphone or start recording a video reply message using a video camera included in a client device associated with the recipient for reply communication 410. The recipient may play back reply communication 410 using replay 434 input button. In addition, the recipient may send reply communication 410 using send 436 input button.

Disposition summary 438 is a summary of dispositions of all recipients of incoming communication 408. Disposition summary 438 may be positive, which is a heart graphic, indifferent, which is an empty graphic, or negative, which is a down arrow graphic as shown in this example. An indicator of incremental recipient disposition toward communication content summary component, such as indicator of incremental recipient disposition toward communication content summary component 308 in FIG. 3, periodically queries a dispositions data store, such as disposition table 322 in FIG. 3, for the disposition of electronic communication recipients and then computes a total disposition score. If a majority of recipient dispositions are positive, then disposition summary 438 is positive. If a majority of recipient dispositions are negative, then disposition summary 438 is negative. Otherwise, no disposition graphic appears, just an outline indicating an indifferent disposition of the recipients.

The recipient's disposition toward communication content automatic indicator 418 graphic reflects the automatically captured disposition of the recipient toward the content of incoming communication 408 and is updated on a predetermined time interval basis, such as, for example, every one to three seconds, as the recipient records reply communication 410. It should be noted that the recipient may select the recipient's disposition toward communication content automatic indicator 418 graphic to keep the automated disposition from being communicated to the sender for privacy purposes. By default, the automatically captured disposition of the recipient is sent along with reply communication 410.

In addition to the automatically captured disposition information displayed in recipient's disposition toward communication content automatic indicator 418, the recipient may manually input the recipient's disposition toward the content of the electronic communication using recipient's disposition toward communication content manual input 424. The recipient's disposition toward communication content manual input 424 graphic first appears as a question mark graphic (?) to indicate that the sender of the electronic communication wants the recipient to manually input the recipient's disposition toward the content of the electronic communication. When the recipient activates the question mark graphic of 424 with a mouse click, for example, the question mark graphic changes to a heart graphic indicating a positive disposition and a subsequent activation of 424 toggles the heart graphic to a down arrow graphic indicating a negative disposition. It should be noted that the recipient may send reply communication 410 with a manual input of a positive disposition (e.g., 1) toward the content of the electronic communication, while the automatically captured disposition of the recipient may indicate a negative disposition (e.g. −1) toward the content of the electronic communication. In such a situation, for summarization purposes, disposition summary 438 will display an indifferent or blank graphic for a total disposition score of zero (0). However, it should be noted that in this situation the sender will see that the recipient was experiencing mixed emotions.

The disposition graphics of a question mark, heart, and down arrow can be visually understood even by a user who cannot understand the content of an electronic communication due to a contextual or physical disability associated with listening to audio track 414, for example. For example, if the recipient of the electronic communication is in a loud café or has a hearing impairment and is unable to perceive audio track 414. The timing of how long it took to record the electronic communication is sent to a disposition analyzer component, such as disposition analyzer component 312 in FIG. 3. Alternative illustrative embodiments may utilize colors, such as red, yellow, and green, numbers, such as 1-10 or −1 to 1, or text, such as Love It! and Awful!, in addition to or instead of disposition graphics 418, 424, and 438 of a question mark, a heart, and a down arrow, respectively.

In some illustrative embodiments, additional recipient actions with regard to a particular electronic communication may result in additional inputs to the disposition analyzer component. For example, illustrative embodiments may store additional comments authored by the recipient regarding a particular electronic communication within a special column of a communication table or a disposition table, such as communication table 320 or disposition table 322 in FIG. 3, linking the additional comments to the particular electronic communication, which was sent via a communication system, such as communication system 304 in FIG. 3.

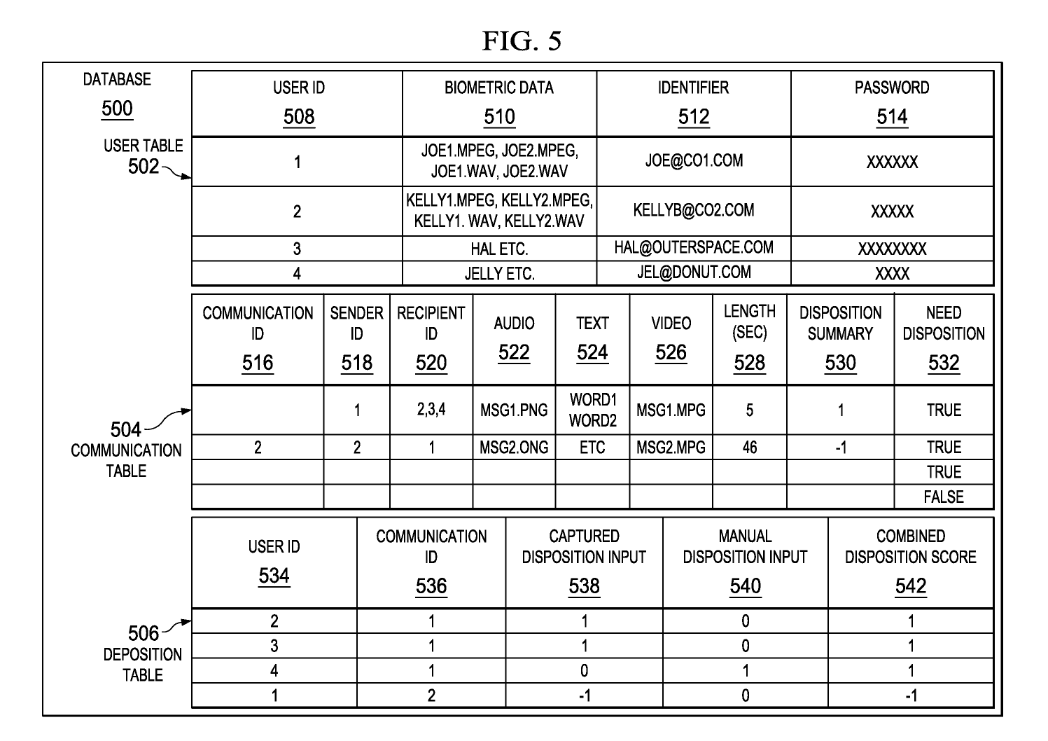

With reference now to FIG. 5, a diagram illustrating database tables is depicted in accordance with an illustrative embodiment. In this example, database 500 stores user table 502, communication table 504, and disposition table 506. However, it should be noted that database 500 may store more or fewer tables than shown. Database 500 may be, for example, database 302 in FIG. 3.

User table 502 may be, for example, user table 324 in FIG. 3. In this example, user table 502 includes user identification number 508, biometric data 510, identifier 512, and password 514. User identification numbers 508 are unique identification numbers that correspond to each of a plurality of users. Biometric data 510 is stored biometric data that corresponds to each of the plurality of users. Illustrative embodiments utilize biometric data 510 for comparison with captured biometric data corresponding to a particular user while the user is perceiving content of a particular electronic communication to determine positive and negative dispositions of the users. Biometric data 510 may be, for example, speech or audio files, video files, and textual files containing happy and unhappy (e.g., sad) expressions of each of the plurality of users. In this example, biometric data 510 stores an mpeg file for a happy facial expression and an unhappy facial expression of users with regard to some sample text. In addition, biometric data 510 stores a way file for a happy verbal reading and an unhappy verbal reading of the same sample text. Biometric data 510 may be captured during an initial user registration process. It should be noted that the mpeg and way files are stored in a file system of a server, such as server 104 in FIG. 1, and not directly in database 500.

Identifier 512 may be, for example, a unique e-mail address or screen name associated with each of the plurality of users. Password 514 is a unique password associated with each of the plurality of users and the users utilize the passwords to login to a communication system, such as communication system 304 in FIG. 3. It should be noted that password 514 may be encrypted.

Communication table 504 may be, for example, communication table 320 in FIG. 3. Communication table 504 stores a plurality of electronic communications that contain multimedia content. In this example, communication table 504 includes communication identification number 516, sender identification number 518, recipient identification number 520, audio 522, text 524, video 526, length 528, disposition summary 530, and need disposition 532.

Communication identification number 516 uniquely identifies each electronic communication. Each electronic communication has a single sender identified by sender identification number 518 and a set of one or more recipients, each identified by recipient identification number 520. Each electronic communication may include an audio file identified by audio 522, a textual file identified by text 524, and/or a video file identified by video 526. In addition, each electronic communication may include graphics, pictures, diagrams, or other types of communication media, for example.

Length 528 identifies a length of time (e.g., seconds) associated with multimedia content of each of the electronic communications. Disposition summary identifies a total disposition score that corresponds to the combined disposition of all of the recipients of a particular electronic communication. Communication table 504 also may track other behaviors of recipients after the set of recipients perceive a particular electronic communication to determine their disposition toward that particular electronic communication. For example, communication table 504 may track whether a particular recipient posted the electronic communication on a social networking website or web forum.

Need disposition 532 identifies whether the sender of a particular electronic communication has requested a manual disposition input of the set of recipients toward content of the electronic communication, which in this example is either true or false. It should be noted that the default is true. If need disposition 532 is true for a particular electronic communication, then an automatic indicator graphic within a communication frame, such as recipient's disposition toward communication content automatic indicator 418 within communication frame 400 in FIG. 4, will be a question mark graphic (?) initially.

Disposition table 506 may be, for example, disposition table 322 in FIG. 3. Disposition table 506 stores the disposition scores corresponding to each of a plurality of users toward the content of a plurality of different electronic communications. In this example, disposition table 506 includes user identification number 534, communication identification number 536, captured disposition input 538, manual disposition input 540, and combined disposition score 542.

Each user is uniquely identified by user identification number 534 and each electronic communication is uniquely identified by communication identification number 536. Captured disposition input 538 identifies an automatically determined disposition of a particular user while the user was perceiving a particular electronic communication. Manual disposition input 540 identifies a manually inputted disposition score by a particular user toward the content of a particular electronic communication. Both captured disposition input 538 and manual disposition input 540 default to a zero (0) disposition score. Combined disposition score 542 is the lowest disposition score or the highest disposition score of captured disposition input 538 and manual disposition input 540. If the disposition scores are negative one (−1) and one (1) for captured disposition input 538 and manual disposition input 540, respectively, then the scores cancel each other and result in is a zero disposition score (0) for combined disposition score 542.

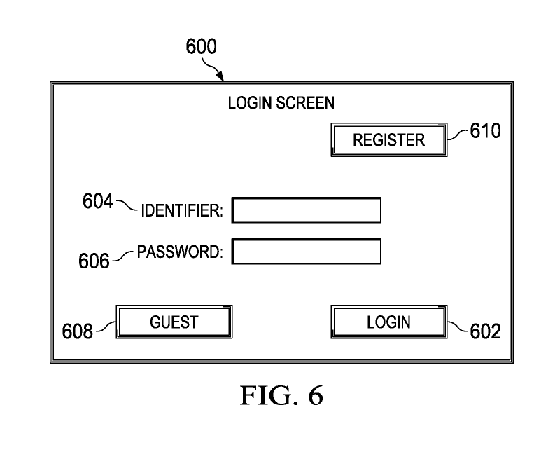

With reference now to FIG. 6, a diagram illustrating a login screen is depicted in accordance with an illustrative embodiment. Login screen 600 may be implemented in a client device, such as client 110 in FIG. 1, for example. A user utilizes login screen 600 to login into a disposition determination system, such as disposition determination system 300 in FIG. 3.

In this example, login screen 600 includes login 602 input button, identifier 604 entry field, password 606 entry field, guest 608 input button, and register 610 input button. However, it should be noted that login screen 600 may include more or fewer components. In other words, login screen 600 only is meant as an example login screen and not meant as a limitation on different illustrative embodiments. Identifier 604 may be, for example, a unique identifier, such as an e-mail address, that corresponds to a particular user. Password 606 also corresponds to the particular user and is compared with a stored password within a user table, such a password 514 within user table 502.

A user may utilize guest 608 to login to the disposition determination system as an anonymous guest. Guest 608 allows the user to send anonymous electronic communications. If the disposition determination system utilizes biometric data to identify the user, then the disposition determination system may utilize subsequent biometric data to determine a disposition of the user toward content of an electronic communication. When the user utilizes register 610 input button, the disposition determination system displays a registration screen to the user.

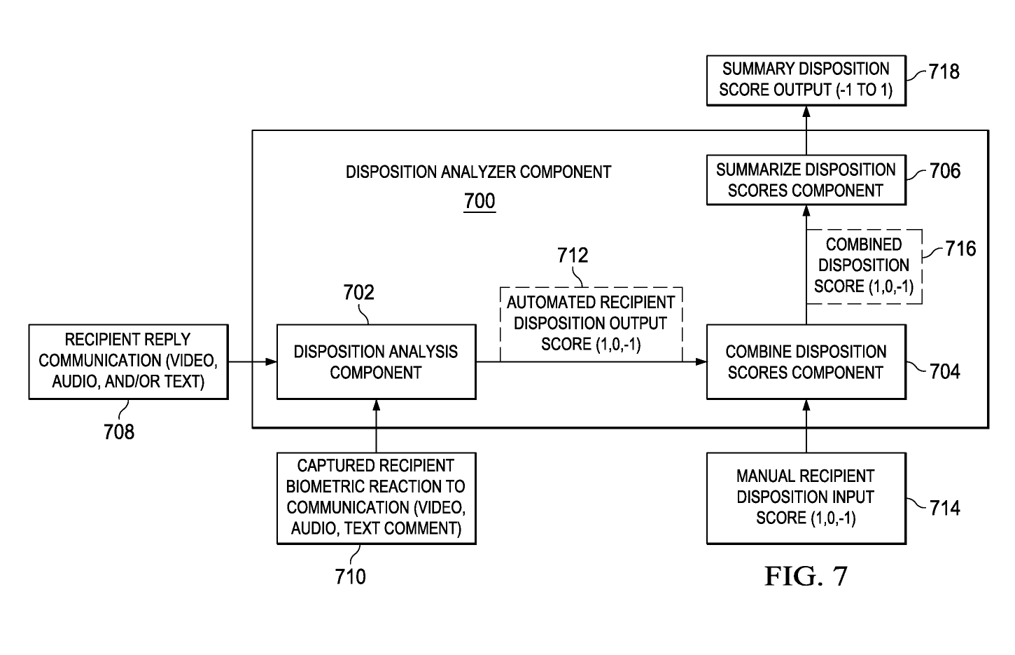

With reference now to FIG. 7, a diagram illustrating a disposition analyzer component is depicted in accordance with an illustrative embodiment. Disposition analyzer component 700 may be implemented in a server computer, such as server 104 in FIG. 1 or data processing system 200 in FIG. 2. Disposition analyzer component 700 may be, for example, disposition analyzer 220 in FIG. 2 or disposition analyzer component 312 in FIG. 3.

Disposition analyzer component 700 determines a recipient's disposition toward content of an electronic communication. In this example, disposition analyzer component 700 includes disposition analysis component 702, combine disposition scores component 704, and summarize disposition scores component 706. Disposition analysis component 702 receives as input recipient reply communication 708, which may include a video track, an audio track, and/or a textual message. Recipient reply communication may be, for example, reply communication 410 that includes video track 428, audio track 430, and textual message 432 in FIG. 4. In addition, disposition analysis component 702 also receives as input captured recipient biometric reaction to communication 710, which may include a video track, an audio track, and/or a textual comment with regard to the recipient's disposition toward content of the electronic communication while the recipient was perceiving the electronic communication.

Disposition analysis component 702 analyzes recipient reply communication 708 and captured recipient biometric reaction to communication 710 to generate automated recipient disposition output score 712, which may be a 1, 0, or −1 disposition score, for example. Combine disposition scores component 704 receives automated recipient disposition output score 712 as input. Combine disposition scores component 704 also receives as input manual recipient disposition input score 714, which may be a 1, 0, or −1 disposition score. Manual recipient disposition input score 714 is a manually inputted disposition score by the recipient toward the content of the electronic communication. Combine disposition scores component 704 combines the disposition scores of automated recipient disposition output score 712 and manual recipient disposition input score 714 to generate combined disposition score 716, which may be a 1, 0, or −1.

Summarize disposition scores component 706 receives as input combined disposition score 716. It should be noted that summarize disposition scores component 706 receives combined disposition scores for each of a set of recipients that received the electronic communication. As a result, summarize disposition scores component 706 summarizes the disposition of the set of recipients to generate summary disposition score output 718, which may be −1 to 1.

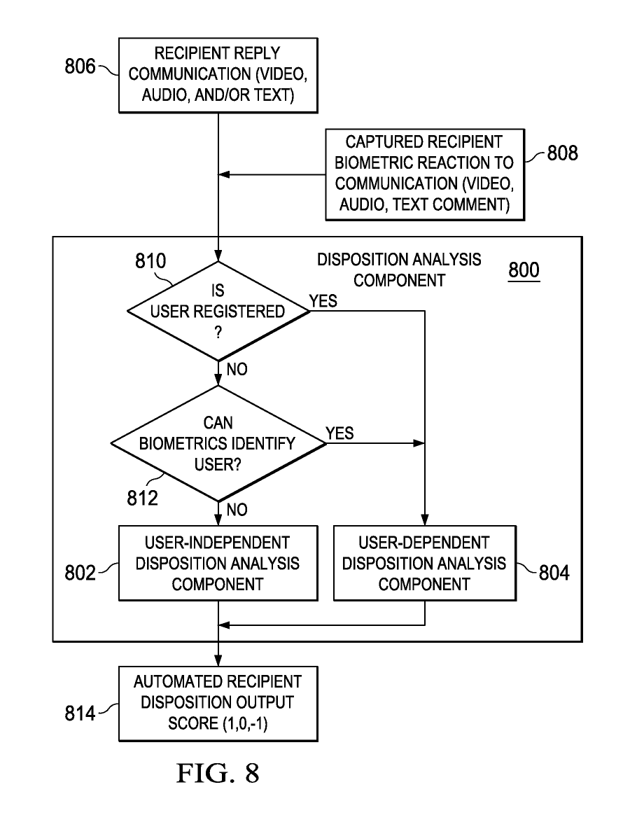

With reference now to FIG. 8, a diagram illustrating a disposition analysis component is depicted in accordance with an illustrative embodiment. Disposition analysis component 800 may be implemented in a server computer, such as server 104 in FIG. 1 or data processing system 200 in FIG. 2. Disposition analysis component 800 may be, for example, disposition analysis component 702 in FIG. 7. In this example, disposition analysis component 800 includes user-independent disposition analysis component 802 and user-dependent disposition analysis component 804.

Disposition analysis component 800 receives as input recipient reply communication 806 and captured recipient biometric reaction to communication 808, such as recipient reply communication 708 and captured recipient biometric reaction to communication 710 in FIG. 7. Then, disposition analysis component 800 makes a determination as to whether the recipient of the electronic communication is a registered user at 810. If disposition analysis component 800 determines that the recipient is a registered user, then disposition analysis component 800 sends recipient reply communication 806 and captured recipient biometric reaction to communication 808 as input to user-dependent disposition analysis component 804. If disposition analysis component 800 determines that the recipient is not a registered user, then disposition analysis component 800 makes another determination as to whether the recipient can be identified using biometric data at 812.

If disposition analysis component 800 determines that the recipient can be identified using biometric data, then disposition analysis component 800 sends recipient reply communication 806 and captured recipient biometric reaction to communication 808 as input to user-dependent disposition analysis component 804. If disposition analysis component 800 determines that the recipient cannot be identified using biometric data, then disposition analysis component 800 sends recipient reply communication 806 and captured recipient biometric reaction to communication 808 as input to user-independent disposition analysis component 802. Either user-independent disposition analysis component 802 or user-dependent disposition analysis component 804 analyzes recipient reply communication 806 and captured recipient biometric reaction to communication 808 to generate automated recipient disposition output score 814, which may be a 1, 0, or −1. Automated recipient disposition output score 814 may be, for example, automated recipient disposition output score 712 in FIG. 7. In this example, 1, 0, and −1 are used to represent negative, neutral, and positive dispositions, respectively.

Video analysis may recognize smiles and other happy expressions and frowns and other unhappy expressions in recipients' faces. If a recipient is identified using registration information or using biometric data, then mpeg files stored during a registration process are used during the video analysis for comparison. Audio analysis may recognize unhappy expressions, such as anger, and other negative expressions and happy expressions, such as laughter, and other positive expressions in recipients' voices. During the registration process, way files are stored of a recipient verbally reading a sample text in a happy voice and an unhappy voice for comparison if the recipient is identified using the registration information or biometric data. Text analysis may recognize happy or unhappy expressions authored by a recipient by recognizing words that carry positive or negative emotions or sentiments.

As an example, if biometric data can identify a recipient or if the recipient is logged in using a unique identifier and password, then the biometric data, if available, may be used to do a user-dependent voice analysis or a user-dependent video analysis. Otherwise, a user-independent general voice or video analysis is performed. Algorithms for user-dependent and user-independent audio and video analysis are known in the art. It should be noted that illustrative embodiments may combine user-dependent and user-independent analysis components.

Further, illustrative embodiments may utilize indirect metrics to identify recipient dispositions based on monitoring and analyzing recipient actions after a recipient perceived an electronic communication. These actions may include, for example, a recipient forwarding an electronic communication or a portion of the electronic communication to someone else or posting the electronic communication on a public website with comments. Video analysis, audio analysis, and/or textual analysis of the comments may indicate the disposition of the recipient toward the content of the electronic communication. Illustrative embodiments may utilize an extra a database field to identity and relate the comments to the particular electronic communication.

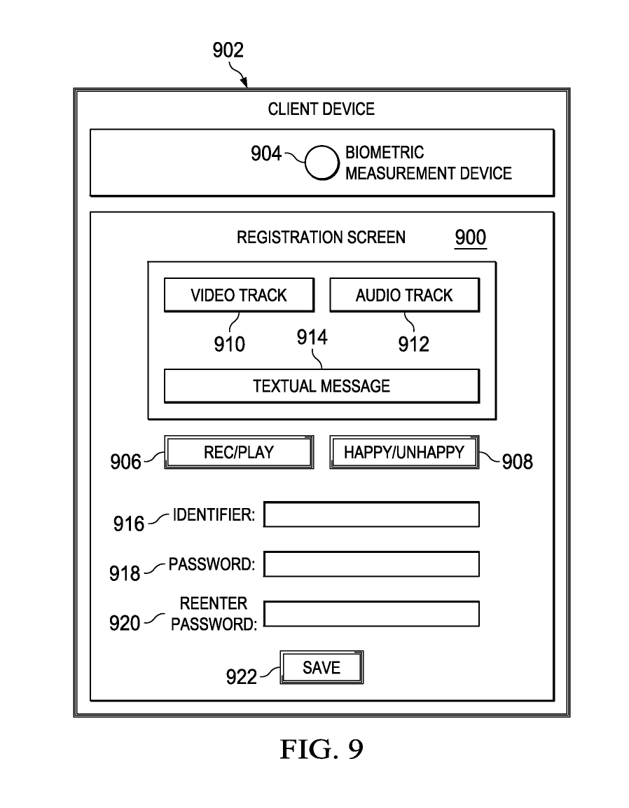

With reference now to FIG. 9, a diagram illustrating a registration screen is depicted in accordance with an illustrative embodiment. Registration screen 900 is implemented in client device 902, such as client 110 in FIG. 1. Client device 902 includes biometric measuring device 904, such as biometric measuring device 404 in FIG. 4. Biometric measuring device 904 represents a set one or more biometric measuring devices, such as an image capturing device, a sound capturing device, a skin arousal capturing device, and/or a brain imaging device.

In this example, registration screen 900 includes rec/play 906 input button, happy/unhappy 908 input button, video track 910 area, audio track 912 area, textual message 914 area, identifier 916 entry field, password 918 entry field, reenter password 920 entry field, and save 922 input button. However, it should be noted that registration screen 900 may include more or fewer components. In other words, registration screen 900 only is meant to be an example registration screen and in not meant to be a limitation on different illustrative embodiments.

Registration screen 900 allows a user to record happy and unhappy video tracks, audio tracks, and/or textual messages as stored biometric data corresponding to the user for comparison with automatically captured biometric data corresponding to the user while the user is perceiving content of an electronic communication. Video track 910 is a video recording of the user's happy and unhappy facial expressions. Audio track 912 is a sound recording of the user's happy and unhappy verbal expressions. Textual message 914 is a textual recording of the user's happy and unhappy textual expressions.

The user utilizes rec/play 906 input button to record or play back the different recordings of user expressions. The user utilizes happy/unhappy 908 input button to indicate whether the user is recording a happy expression or an unhappy expression. The user can enter an e-mail address, for example, within identifier 916 entry field, a password within password 918 entry field, and confirm the password within reentry password 920 entry field. The user can save the entire result by utilizing save 922 input button.

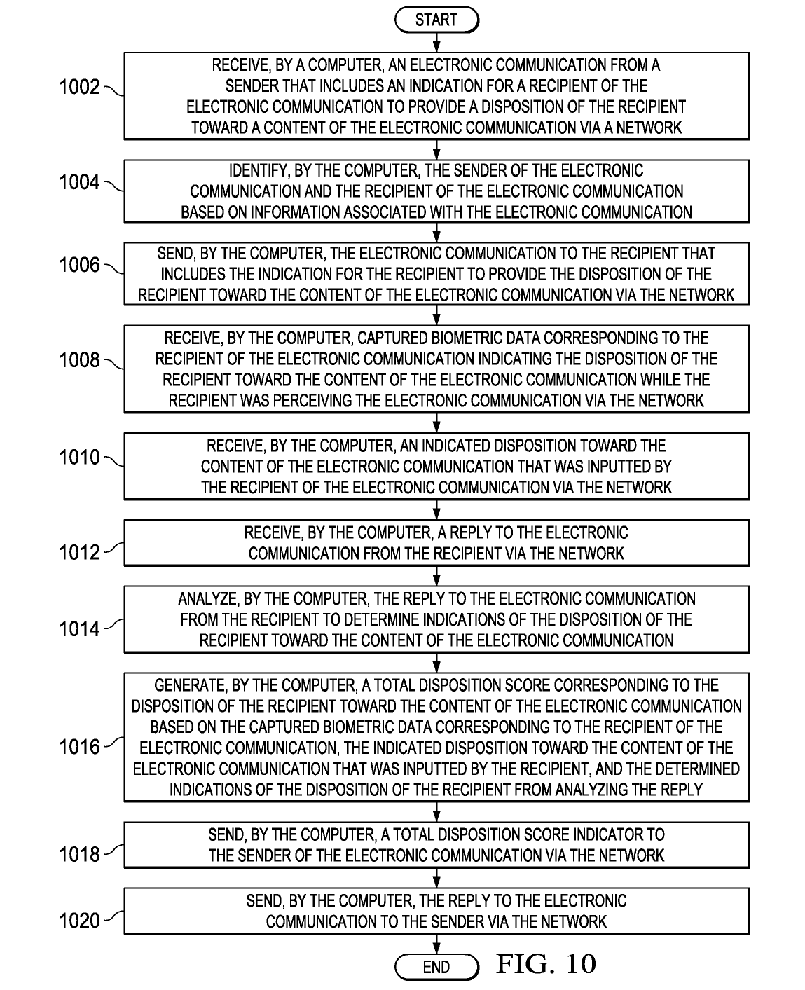

With reference now to FIG. 10, a flowchart illustrating a process for generating a disposition score corresponding to a disposition of a recipient toward content of an electronic communication is shown in accordance with an illustrative embodiment. The process shown in FIG. 10 may be implemented in a computer, such as, for example, server 104 in FIG. 1 or data processing system 200 in FIG. 2.

The process begins when the computer receives an electronic communication from a sender that includes an indication for a recipient of the electronic communication to provide a disposition of the recipient toward a content of the electronic communication via a network (step 1002). The computer identifies the sender of the electronic communication and the recipient of the electronic communication based on information associated with the electronic communication (step 1004). In addition, the computer sends the electronic communication to the recipient that includes the indication for the recipient to provide the disposition of the recipient toward the content of the electronic communication via the network (step 1006).

Subsequently, the computer receives captured biometric data corresponding to the recipient of the electronic communication indicating the disposition of the recipient toward the content of the electronic communication while the recipient was perceiving the electronic communication via the network (step 1008). The computer also receives an indicated disposition toward the content of the electronic communication that was inputted by the recipient of the electronic communication via the network (step 1010). Further, the computer receives a reply to the electronic communication from the recipient via the network (step 1012).

Afterward, the computer analyzes the reply to the electronic communication from the recipient to determine indications of the disposition of the recipient toward the content of the electronic communication (step 1014). Then, the computer generates a total disposition score corresponding to the disposition of the recipient toward the content of the electronic communication based on the captured biometric data corresponding to the recipient of the electronic communication, the indicated disposition toward the content of the electronic communication that was inputted by the recipient, and the determined indications of the disposition of the recipient from analyzing the reply (step 1016). Subsequently, the computer sends a total disposition score indicator to the sender of the electronic communication via the network (step 1018). In addition, the computer sends the reply to the electronic communication to the sender via the network (step 1020). Thereafter, the process terminates.

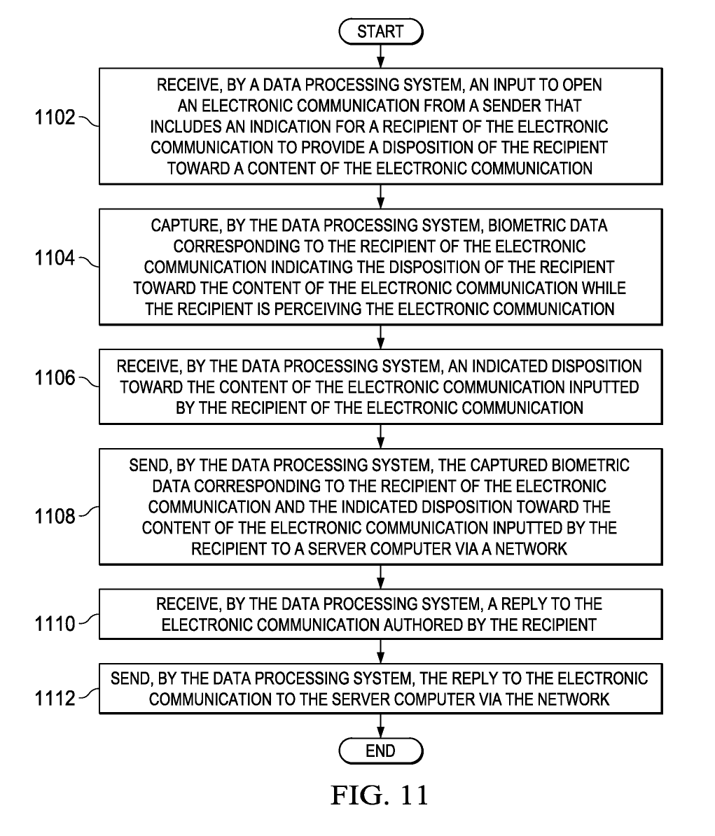

With reference now to FIG. 11, a flowchart illustrating a process for sending captured biometric data corresponding to a recipient of an electronic communication indicating a disposition of the recipient toward a content of the electronic communication and an indicated disposition toward the content of the electronic communication inputted by the recipient is shown in accordance with an illustrative embodiment. The process shown in FIG. 11 may be implemented in a computer, such as, for example, client 110 in FIG. 1 or data processing system 200 in FIG. 2.

The process begins when the data processing system receives an input to open an electronic communication from a sender that includes an indication for a recipient of the electronic communication to provide a disposition of the recipient toward a content of the electronic communication (step 1102). Then, the data processing system captures biometric data corresponding to the recipient of the electronic communication indicating the disposition of the recipient toward the content of the electronic communication while the recipient is perceiving the electronic communication (step 1104). In addition, the data processing system receives an indicated disposition toward the content of the electronic communication inputted by the recipient of the electronic communication (step 1106).

Subsequently, the data processing system sends the captured biometric data corresponding to the recipient of the electronic communication and the indicated disposition toward the content of the electronic communication inputted by the recipient to a server computer, such as server 104 in FIG. 1, via a network, such as network 102 in FIG. 1 (step 1108). Afterward, the data processing system receives a reply to the electronic communication authored by the recipient (step 1110). Then, the data processing system sends the reply to the electronic communication to the server computer via the network (step 1112). Thereafter, the process terminates.

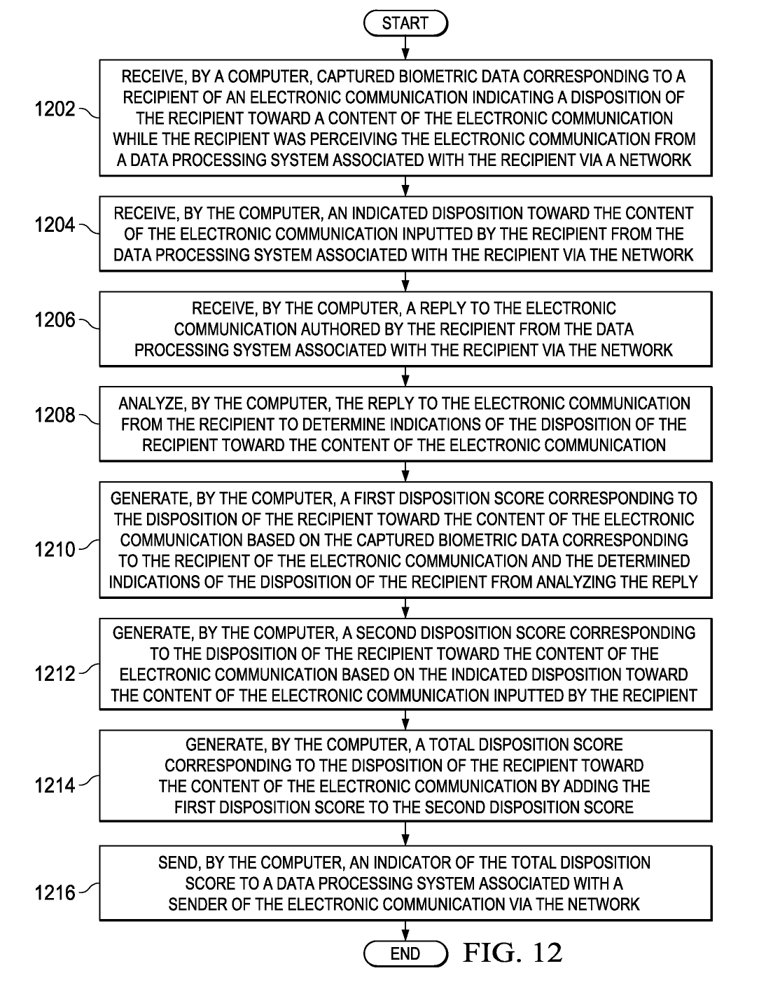

With reference now to FIG. 12, a flowchart illustrating a process for sending an indicator of a disposition of a recipient toward a content of an electronic communication to a sender of the electronic communication is shown in accordance with an illustrative embodiment. The process shown in FIG. 12 may be implemented in a computer, such as, for example, server 104 in FIG. 1 or data processing system 200 in FIG. 2.

The process begins when the computer receives captured biometric data corresponding to a recipient of an electronic communication indicating a disposition of the recipient toward a content of the electronic communication while the recipient was perceiving the electronic communication from a data processing system, such as client 110 in FIG. 1, associated with the recipient via a network, such as network 102 in FIG. 1 (step 1202). In addition, the computer receives an indicated disposition toward the content of the electronic communication inputted by the recipient from the data processing system associated with the recipient via the network (step 1204). Further, the computer receives a reply to the electronic communication authored by the recipient from the data processing system associated with the recipient via the network (step 1206).

Afterward, the computer analyzes the reply to the electronic communication from the recipient to determine indications of the disposition of the recipient toward the content of the electronic communication (step 1208). Then, the computer generates a first disposition score corresponding to the disposition of the recipient toward the content of the electronic communication based on the captured biometric data corresponding to the recipient of the electronic communication and the determined indications of the disposition of the recipient from analyzing the reply (step 1210). Further, the computer generates a second disposition score corresponding to the disposition of the recipient toward the content of the electronic communication based on the indicated disposition toward the content of the electronic communication inputted by the recipient (step 1212).

Subsequently, the computer generates a total disposition score corresponding to the disposition of the recipient toward the content of the electronic communication by adding the first disposition score to the second disposition score (step 1214). Then, the computer sends an indicator of the total disposition score to a data processing system, such as client 114 in FIG. 1, associated with a sender of the electronic communication via the network (step 1216). Thereafter, the process terminates.

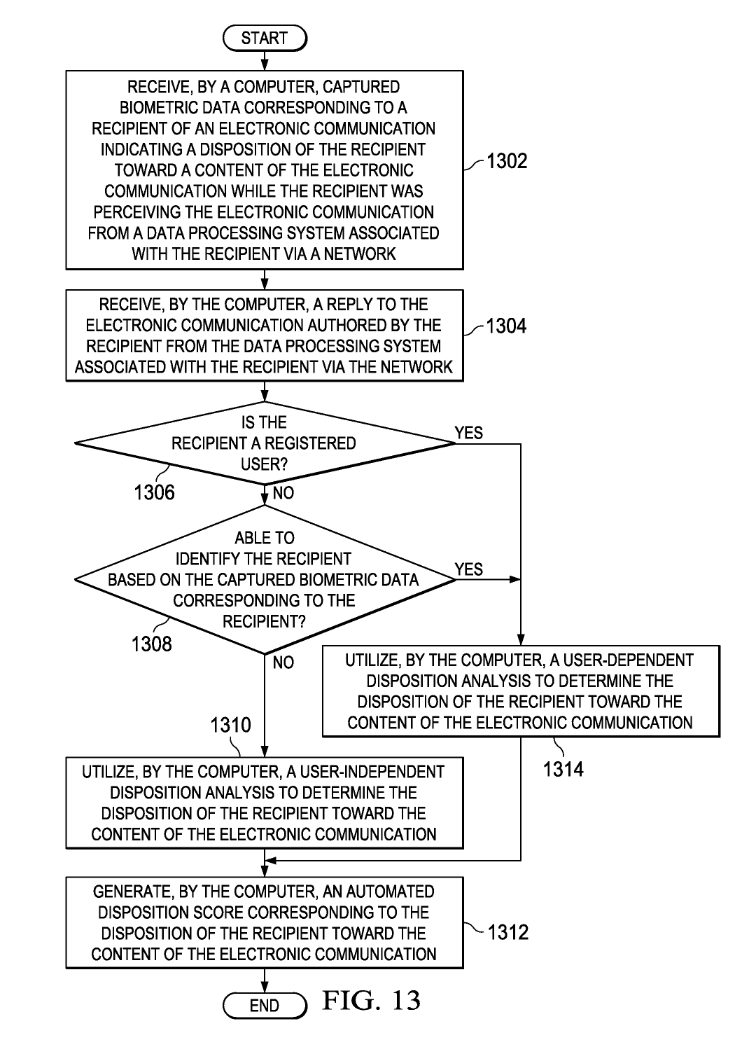

With reference now to FIG. 13, a flowchart illustrating a process for automatically generating a disposition score corresponding to a disposition of a recipient toward content of an electronic communication is shown in accordance with an illustrative embodiment. The process shown in FIG. 13 may be implemented in a computer, such as, for example, server 104 in FIG. 1 or data processing system 200 in FIG. 2.

The process begins when the computer receives captured biometric data corresponding to a recipient of an electronic communication indicating a disposition of the recipient toward a content of the electronic communication while the recipient was perceiving the electronic communication from a data processing system associated with the recipient via a network (step 1302). In addition, the computer receives a reply to the electronic communication authored by the recipient from the data processing system associated with the recipient via the network (step 1304). Subsequently, the computer makes a determination as to whether the recipient is a registered user (step 1306).

If the computer determines that the recipient is not a registered user, no output of step 1306, then the computer makes a determination as to whether the computer is able to identify the recipient based on the captured biometric data corresponding to the recipient (step 1308). If the computer determines that the computer is unable to identify the recipient based on the captured biometric data corresponding to the recipient, no output of step 1308, then the computer utilizes a user-independent disposition analysis to determine the disposition of the recipient toward the content of the electronic communication (step 1310). Afterward, the computer generates an automated disposition score corresponding to the disposition of the recipient toward the content of the electronic communication (step 1312). Thereafter, the process terminates.

Returning again to step 1306, if the computer determines that the recipient is a registered user, yes output of step 1306, then the computer utilizes a user-dependent disposition analysis to determine the disposition of the recipient toward the content of the electronic communication (step 1314). Thereafter, the process returns to step 1312. Returning again to step 1308, if the computer determines that the computer is able to identify the recipient based on the captured biometric data corresponding to the recipient, yes output of step 1308, then the process returns to step 1314.

Thus, illustrative embodiments provide a computer-implemented method, computer system, and computer program product for updating a sender of an electronic communication on a disposition of a recipient toward content of the electronic communication. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for determining a disposition of an electronic communication recipient, the computer-implemented method comprising:
receiving, by a computer, an electronic communication from a sender;
sending, by the computer, the electronic communication to a recipient; and
receiving, by the computer, captured biometric data corresponding to the recipient of the electronic communication indicating the disposition of the recipient toward the content of the electronic communication while the recipient was perceiving the electronic communication.

2. The computer-implemented method of claim 1, further comprising:
receiving, by the computer, an indicated disposition toward the content of the electronic communication that was inputted by the recipient of the electronic communication.

3. The computer-implemented method of claim 2, further comprising:
receiving, by the computer, a reply to the electronic communication from the recipient; and
analyzing, by the computer, the reply to the electronic communication from the recipient to determine indications of the disposition of the recipient toward the content of the electronic communication.

4. The computer-implemented method of claim 3, further comprising:
generating, by the computer, a total disposition score corresponding to the disposition of the recipient toward the content of the electronic communication based on the captured biometric data corresponding to the recipient of the electronic communication, the indicated disposition toward the content of the electronic communication that was inputted by the recipient, and the determined indications of the disposition of the recipient from analyzing the reply.

5. The computer-implemented method of claim 4, further comprising:
sending, by the computer, the total disposition score corresponding to the disposition of the recipient toward the content of the electronic communication to the sender of the electronic communication.

6. The computer-implemented method of claim 4, further comprising:
generating, by the computer, a first disposition score corresponding to the disposition of the recipient toward the content of the electronic communication based on the captured biometric data corresponding to the recipient of the electronic communication and the determined indications of the disposition of the recipient from analyzing the reply;
generating, by the computer, a second disposition score corresponding to the disposition of the recipient toward the content of the electronic communication based on the indicated disposition toward the content of the electronic communication inputted by the recipient; and
generating, by the computer, the total disposition score corresponding to the disposition of the recipient toward the content of the electronic communication by adding the first disposition score to the second disposition score.

7. The computer-implemented method of claim 1, further comprising:
responsive to the computer identifying the recipient based on the captured biometric data corresponding to the recipient, utilizing, by the computer, a user-dependent disposition analysis to determine the disposition of the recipient toward the content of the electronic communication.

8. The computer-implemented method of claim 1, further comprising:
responsive to the computer not identifying the recipient based on the captured biometric data corresponding to the recipient, utilizing, by the computer, a user-independent disposition analysis to determine the disposition of the recipient toward the content of the electronic communication.

9. The computer-implemented method of claim 1, further comprising:
generating, by the computer, an automated disposition score corresponding to the disposition of the recipient toward the content of the electronic communication based on one of a user-dependent disposition analysis or a user-independent disposition analysis.

10. The computer-implemented method of claim 1, wherein the captured biometric data corresponding to the recipient of the electronic communication indicating the disposition of the recipient toward the content of the electronic communication while the recipient was perceiving the electronic communication is captured using a brain mapping device.

11. A computer system for determining a disposition of an electronic communication recipient, the computer system comprising:
a bus system;
a storage device connected to the bus system, wherein the storage device stores computer readable program code; and
a processor unit connected to the bus system, wherein the processor unit executes the computer readable program code to receive an electronic communication from a sender; send the electronic communication to a recipient; and receive captured biometric data corresponding to the recipient of the electronic communication indicating the disposition of the recipient toward the content of the electronic communication while the recipient was perceiving the electronic communication.

12. The computer system of claim 11, wherein the processor unit further executes the computer readable program code to receive an indicated disposition toward the content of the electronic communication that was inputted by the recipient of the electronic communication.

13. The computer system of claim 12, wherein the processor unit further executes the computer readable program code to receive a reply to the electronic communication from the recipient; and analyze the reply to the electronic communication from the recipient to determine indications of the disposition of the recipient toward the content of the electronic communication.

14. The computer system of claim 13, wherein the processor unit further executes the computer readable program code to generate a total disposition score corresponding to the disposition of the recipient toward the content of the electronic communication based on the captured biometric data corresponding to the recipient of the electronic communication, the indicated disposition toward the content of the electronic communication that was inputted by the recipient, and the determined indications of the disposition of the recipient from analyzing the reply.

15. A computer program product stored on a computer readable storage medium having computer readable program code encoded thereon that is executable by a computer for determining a disposition of an electronic communication recipient, the computer program product comprising:
computer readable program code to receive an electronic communication from a sender;
computer readable program code to send the electronic communication to a recipient; and
computer readable program code to receive captured biometric data corresponding to the recipient of the electronic communication indicating the disposition of the recipient toward the content of the electronic communication while the recipient was perceiving the electronic communication.

16. The computer program product of claim 15, further comprising:
computer readable program code to receive an indicated disposition toward the content of the electronic communication that was inputted by the recipient of the electronic communication.

17. The computer program product of claim 16, further comprising:
computer readable program code to receive a reply to the electronic communication from the recipient; and
computer readable program code to analyze the reply to the electronic communication from the recipient to determine indications of the disposition of the recipient toward the content of the electronic communication.

18. The computer program product of claim 17, further comprising:
computer readable program code to generate a total disposition score corresponding to the disposition of the recipient toward the content of the electronic communication based on the captured biometric data corresponding to the recipient of the electronic communication, the indicated disposition toward the content of the electronic communication that was inputted by the recipient, and the determined indications of the disposition of the recipient from analyzing the reply.

19. The computer program product of claim 18, further comprising:
computer readable program code to send the total disposition score corresponding to the disposition of the recipient toward the content of the electronic communication to the sender of the electronic communication.

20. The computer program product of claim 18, further comprising:
computer readable program code to generate a first disposition score corresponding to the disposition of the recipient toward the content of the electronic communication based on the captured biometric data corresponding to the recipient of the electronic communication and the determined indications of the disposition of the recipient from analyzing the reply;
computer readable program code to generate a second disposition score corresponding to the disposition of the recipient toward the content of the electronic communication based on the indicated disposition toward the content of the electronic communication inputted by the recipient; and
computer readable program code to generate the total disposition score corresponding to the disposition of the recipient toward the content of the electronic communication by adding the first disposition score to the second disposition score.
